(19) United States
(12) Patent Application Publication
(10) Pub. No.: US 2006/0256122 A1
(43) Pub. Date: Nov. 16, 2006

(54) Method and apparatus for streaming data from multiple devices over a single data bus

(76) Inventors: Barinder Singh Rai, Surrey (CA); Phil Van Dyke, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/128,545

(22) Filed: May 13, 2005

(51) Int. Cl. G09G 5/36

(52) U.S. Cl. 345/547

(57) ABSTRACT

A method and apparatus for streaming data from multiple devices over a single data bus includes causing first and second data streams produced respectively by first and second devices to be synchronized, and inserting into each of the data streams a plurality of corresponding high impedance states to form respective modified data streams in such a manner that the data corresponding to one of the modified data streams is present at the same time that another of the modified data streams is in a high impedance state, and superimposing the modified data streams on the bus for selecting the data.

### FIELD OF THE INVENTION

The present invention relates to a method and apparatus for streaming data from multiple devices over a single data bus. More particularly, the invention relates to graphics display systems comprising a graphics controller for interfacing multiple cameras to a display device.

### BACKGROUND

Graphics display systems, such as mobile or cellular telephones, typically employ a graphics controller as an interface between one or more providers of image data and a graphics display device such as an LCD panel or panels. In a mobile telephone, the providers of image data are typically a host, such as a CPU, and a camera. The host and camera transmit image data to the graphics controller for ultimate display on the display device. The host also transmits control data to both the graphics controller and the camera to control the operation of these devices.

The graphics controller provides various processing options for processing image data received from the host and camera. For example, the graphics controller may compress or decompress, e.g., JPEG encode or decode, incoming or outgoing image data, crop the image data, resize the image data, scale the image data, and color convert the image data according to one of a number of alternative color conversion schemes. All these image processing functions provided by the graphics controller are responsive to and may be directed by control data provided by the host.

The host also transmits control data for controlling the camera to the graphics controller, the graphics controller in turn programming the camera to send one or more frames of image data acquired by the camera to the graphics controller. Where, as is most common, the graphics controller is a separate integrated circuit or “chip,” and the graphics controller, the host, and the camera are all remote from one another, instructions are provided to the camera, and image data from the camera are provided to the graphics controller for manipulation and ultimate display, through a camera interface in the graphics controller.

Often, cellular telephones include two cameras. For example, it may be desirable to use one camera to image the user of the telephone while a call is being placed, and to use another camera to image scenery or other objects of interest that the caller would like to transmit in addition to his or her own image. In such cellular telephones, two camera interfaces are provided in the graphics controller.

The graphics controller cannot process parallel streams of data from multiple cameras, so that only one camera interface can be active at a given time. However, even an inactive camera interface consumes power. Therefore, as the present inventors have recognized, there is a need for a method and apparatus for streaming data from multiple devices over a single data bus.

### SUMMARY

A method for streaming data from multiple devices over a single data bus comprises causing first and second data streams produced respectively by first and second devices to be synchronized, and inserting into each of the data streams a plurality of corresponding high impedance states to form respective modified data streams in such a manner that the data corresponding to one of the modified data streams is present at the same time that another of the modified data streams is in a high impedance state, and superimposing the modified data streams on the bus for selecting the data.

An apparatus for streaming data from multiple devices comprises a clock source for synchronizing first and second data streams produced respectively by two of the devices. The apparatus also includes a switching circuit for inserting into the first data stream a plurality of high impedance states to form a first modified data stream, and for inserting into the second data stream a plurality of high impedance states to form a second modified data stream. Additionally, the apparatus includes a controller for controlling the switching device in such manner that data corresponding to one of the first and second modified data streams is present at the same time that the other of the first and second modified data streams is in a high impedance state. Preferably, the apparatus also includes a bus for receiving the modified first and second data streams in superimposition.

Embodiments of the invention are also directed to systems which employ methods and apparatus for streaming data from multiple devices over a single data bus.

This summary is provided only for generally determining what follows in the drawings and detailed description. This summary is not intended to fully describe the invention. As such, it should not be used limit the scope of the invention. Objects, features, and advantages of the invention will be readily understood upon consideration of the following detailed description taken in conjunction with the accompanying drawings.

### BRIEF DESCRIPTION OF THE DRAWINGS

FIG. 1 is a block diagram of a graphics display system providing for streaming data from multiple cameras over a single camera data bus according to an embodiment of the invention.

FIG. 2 is a timing diagram showing a set of original and modified data streams corresponding to two camera modules according to an embodiment of the invention.

FIG. 3 is a timing diagram showing an alternative set of original and modified data streams corresponding to the data streams of FIG. 2.

FIG. 4 is a timing diagram showing a set of original and modified data streams corresponding to three camera modules according to an embodiment of the invention.

FIG. 5 is a timing diagram showing a clock signal and its relation to the original data streams of FIG. 2.

FIG. 6 is a timing diagram showing the clock signal of FIG. 5 and its relation to the modified data streams of FIG. 2.

FIG. 7 is a timing diagram showing a modification to the clock signal of FIG. 5 and its relation to the modified data streams of FIG. 2.

### DETAILED DESCRIPTION OF PREFERRED EMBODIMENTS

Embodiments of the invention relate generally to methods and apparatus for streaming data from multiple devices over a single data bus. Particular embodiments pertain more particularly to graphics display systems comprising a graphics controller for interfacing multiple cameras to a display device; however, it should be understood that the principles described have wider applicability. One preferred graphics display system is a mobile telephone, wherein the graphics controller is a separate integrated circuit from the remaining elements of the system, but it should be understood that graphics controllers according to the invention may be used in other systems, and may be integrated into such systems as desired without departing from the principles of the invention. Reference will now be made in detail to specific preferred embodiments of the invention, examples of which are illustrated in the accompanying drawings. Wherever possible, the same reference numbers are used in the drawings and the description to refer to the same or like parts.

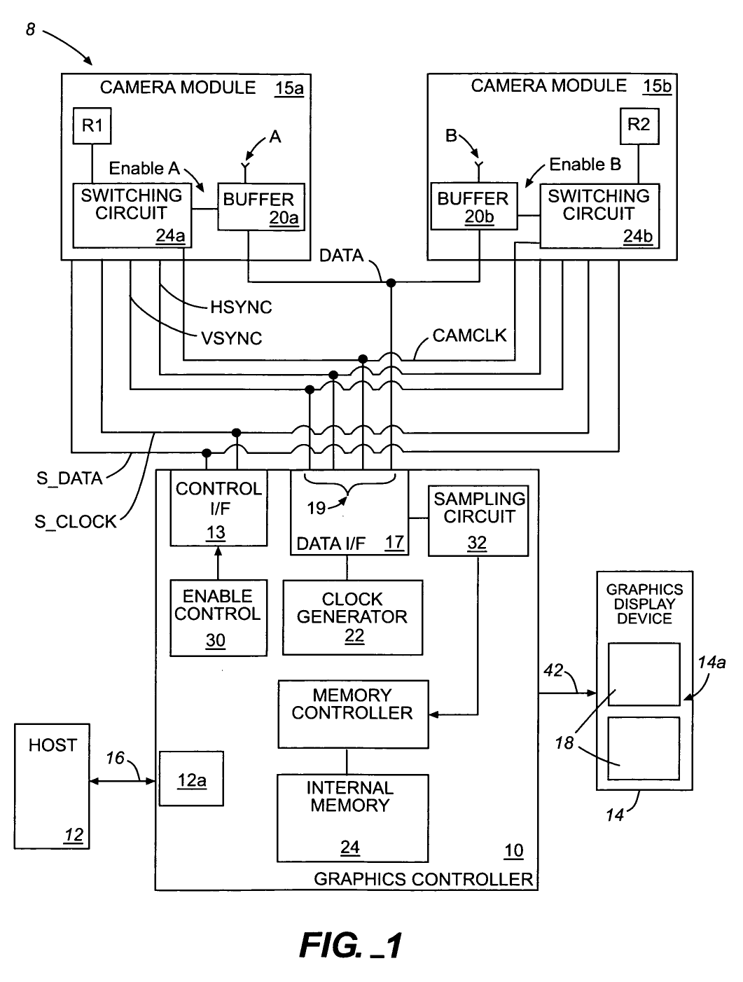

Referring to FIG. 1, a system 8 including a graphics controller 10 according to the invention is shown. The system 8 may be any digital system or appliance providing graphics output; where it is a portable appliance such as a mobile telephone, it is powered by a battery (not shown). The system 8 typically includes a host 12, and a graphics display device 14, and further includes at least two camera modules 15a, 15b. The graphics controller 10 interfaces the host and cameras with the display device. The graphics controller is typically and preferably separate (or remote) from the host, camera, and display device.

The host 12 is preferably a microprocessor, but may be a digital signal processor, computer, or any other type of device adapted for controlling digital circuits. The host communicates with the graphics controller 10 over a bus 16 to a host interface 12a in the graphics controller.

The display device 14 has one or more display panels 14a with corresponding display areas 18. The one or more display panels 14a are adapted for displaying on their display areas pixels of image data (“pixel data”). The pixel data are typically 24 bit sets of three 8-bit color components but may have any other digital (or numerical) range. LCDs are typically used as display devices in mobile telephones, but any device(s) capable of rendering pixel data in visually perceivable form may be employed.

The camera modules 15a, 15b (or “cameras 15”) each acquire pixel data and provide the pixel data to the graphics controller 10 in addition to any pixel data provided by the host. The cameras are programmatically controlled through a serial “control” interface 13. The control interface 13 provides for transmitting control data (“S_Data”) to and from the respective cameras 15 and a clock signal (“S_Clock”) for clocking the control data. The bus serving the interface 13 is preferably that known in the art as an inter-integrated circuit (“I²C”) bus. Each I²C data transfer starts with an ID being transmitted and only the device with the matching ID receives or transmits data for that transfer. The data from the cameras 15 are typically processed by the graphics controller 10, such as by being cropped, scaled, and resized, or JPEG encoded, and that the data received from camera modules 15a and 15b are stored in respective portions of an internal memory 24.

In contrast to the prior art and in accordance with the invention, the graphics controller 10 includes a single, parallel “data” interface 17 for receiving pixel data streamed from the cameras 15 to the graphics controller. The data interface 17 is coupled to a bus 19 having DATA and other lines. The data interface 17 provides the data received on the bus to the graphics controller 10, along with vertical and horizontal synchronizing signals (“VSYNC” and “HSYNC”). The data interface 17 provides a clock signal CAMCLK that is transmitted from the graphics controller to the cameras 15 over a dedicated line of the parallel bus 19. The graphics controller 10 includes a clock generator 22 that produces the (common) clock signal CAMCLK. Other clock sources, either located within or external to, the graphics controller 10 may be substituted, in whole or in part, for the clock generator 10. The exemplary graphics controller 10 also includes an enable control for setting registers in the camera as described below, and a sampling circuit 32 for sampling the data streams received from the data interface 17.

Also in contrast to the prior art and in accordance with the invention, the camera output is modified to cooperate with the camera interface 17. The cameras modules 15a, 15b include, in one embodiment, respective switching circuits 24a, 24b, buffers 20a, 20b, and control registers R1, R2. The signal CAMCLK is provided to the switching circuits 24a, 24b. Each switching circuit is coupled to an enable/disable input of its respective buffer and to its respective control register. Input to the buffers 20a, 20b are provided at respective inputs A and B. Each buffer 20 may be enabled or disabled, at the respective point labeled “Enable,” to either place valid data on its outputs or to place its outputs in a high impedance state. While the buffers 20 may be provided integrally with the cameras (as shown in FIG. 1), it is contemplated that one or both buffers may be provide separately from the cameras. Similarly, while the switching circuits 24a, 24b may be provided integrally with the cameras, it is contemplated that one or both switching circuits may be provide separately from the cameras. Further, the control registers R1, R2 may be coupled to or disposed integrally within the switching circuits 24a, 24b.

In a preferred embodiment, the graphics controller initiates the clock signal CAMCLK and upon first receipt of the clock signal, each camera determines the clock pulse on which to initiate the transmission of pixel data to the graphics controller. A camera determines which clock pulse to initiate data transmission by consulting a temporal-shift register (not shown) in the camera which the graphics controller 10 programs through the control interface 13. The value stored in the temporal-shift register specifies the number of clock pulses the camera must wait before transmitting the first line of a data stream of pixel data. By this means, data streams output from the cameras may be temporally shifted relative to one another by amounts that are integer multiples of the period of the signal CAMCLK. Notwithstanding any relative temporal shifting, the data streams output from the cameras remain synchronized to the common clocking signal CAMCLK.

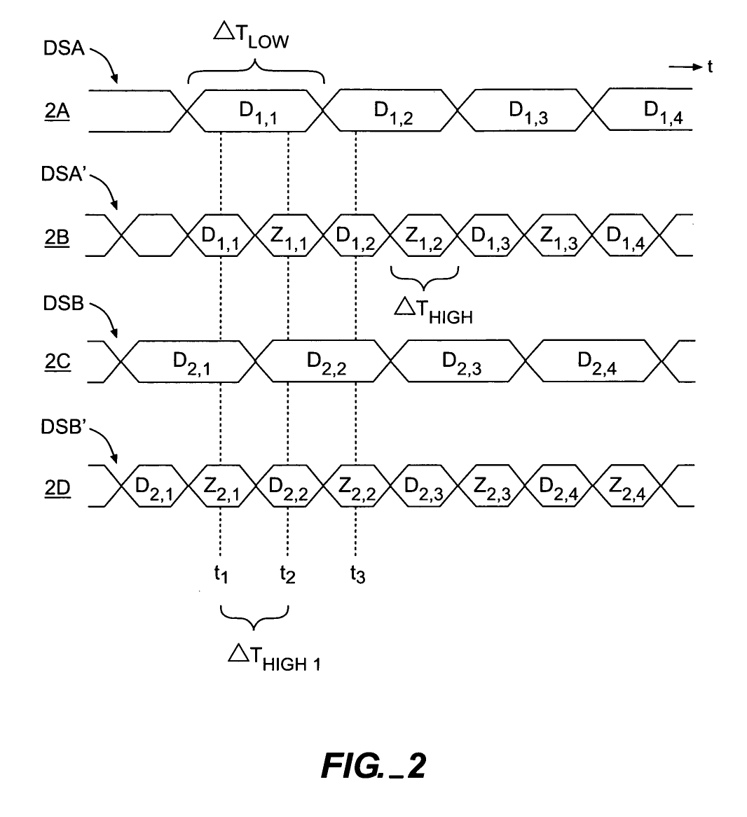

FIG. 2 shows on lines 2A and 2C, respectively data streams DSA and DSB. The data streams are typical for the cameras 15. In this example, DSA is assumed to correspond to the camera module 15a, and DSB is assumed to correspond to the camera module 15b. In one embodiment, the data stream DSA includes 24 bit pixel data D₁₁, D_{1,2}, and so on, and the data stream DSB includes pixel data D₂₁, D_{2,2}, and so on. The data streams DSA and DSB are input at A and B respectively to respective buffers 20a and 20b.

For clarity of presentation, the data stream DSB is shown temporally shifted with respect to the data stream DSA by an amount that is equal to half the period of a pixel datum (ΔT_{LOW}), to achieve an anti-parallel alignment in which the two data streams are 180 degrees out of phase. Such a shift could be obtained in practice, in a similar manner to that used for obtaining temporal shifts as described above, by utilizing a derivative clock signal that is divided down from the clock signal CAMCLK.

In a preferred embodiment, the data streams DSA and DSB are interleaved for transmission to the graphics controller 10 over the DATA lines of the interface 17. In other embodiments, two or more data streams are interleaved. By interleaving the data streams from multiple cameras, data from the multiple cameras may be transmitted over the interface 17 at essentially the same time.

To permit the interleaving of the two original data streams DSA and DSB, high impedance (“High-Z”) states are inserted into the original data streams to produce corresponding modified data streams DSA′ and DSB′. For example, with reference to FIG. 2, High-Z states Z_{1,1}, Z_{1,2}, Z_{1,3} are interleaved between the pixel data in the relatively low (clock) frequency (period “ΔT_{LOW}”) data stream DSA of line 2A to produce a relatively high (clock) frequency (period “ΔT_{HIGH1}”) data stream DSA′ such as shown in line 2B. The data stream DSA′ is relatively high frequency compared to the data stream DSA because it includes High-Z states along with the same pixel data in the original data stream DSA. In the example, DSA′ is twice the frequency of DSA. Other frequencies are contemplated. Similarly, High-Z states Z_{2,1}, Z_{2,2}, Z_{2,3} are interleaved between the pixel data in the data stream DSB of line 2C to produce the corresponding data stream DSB′ shown in line 2D.

The modified data streams DSA′ and DSB′ are preferably interleaved in a particular manner. FIG. 2 shows that while pixel data are validly asserted for one of the data streams, the other data stream is in a High-Z state, and vice versa. The original data streams DSA and DSB may be temporally shifted, or the modified data streams DSA′ and DSB′ may be temporally shifted to the same effect, an example of which is made apparent by comparison of the horizontal (time axis “t”) alignment of line 2A with line 2C, and line 2B with line 2D.

As an example, referring to FIG. 2, at time t₁ the pixel data D_{1,1} of the data stream DSA′ coincides with the High-Z state Z_{2,1} of the data stream DSB′. In this example, DSA′ is assumed to correspond to the camera module 15a, and DSB′ is assumed to correspond to the camera module 15b. At time t₂ the pixel data D_{2,2} of the data stream DSB′ coincides with the High-Z state Z_{1,1} of the data stream DSA′. And at time t₃ the pixel data D_{1,2} of the data stream DSA′ coincides with the High-Z state Z_{2,2} of the data stream DSB′. Accordingly, the two data streams DSA′ and DSB′ may be superimposed on the bus 19 and valid data corresponding to just one of the cameras 15 may be selected at the clock rate indicated by the period ΔT_{HIGH1}.

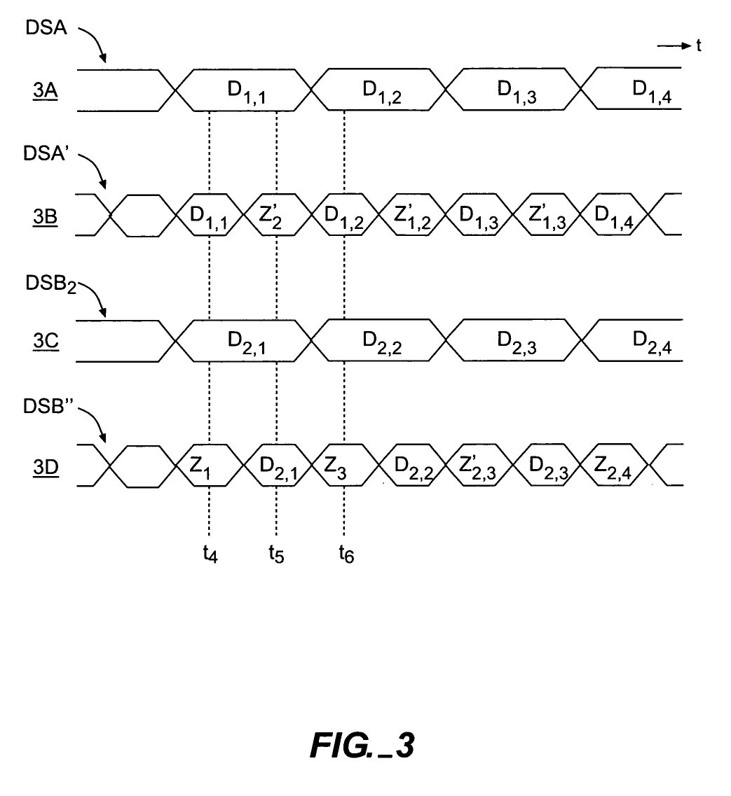

Turning to FIG. 3, lines 3A-3D illustrate producing modified data streams for super-positioning on the bus 19, but without temporally shifting the data streams relative to each other. Lines 3A and 3C show the data stream DSA and a data stream DSB₂, which is analogous to the data stream DSB of line 2C of FIG. 2. The data streams DSA and DSB₂ correspond to the two camera modules 15a and 15b. The data steam DSB₂ differs in its relation to the data stream DSA from the data stream DSB in that the data stream DSB₂ is not temporally shifted relative to the data stream DSA. More specifically, in this example, the data streams DSA and DSB₂ of FIG. 3 are maintained in a parallel alignment in which an nth pixel of the data stream output from one of the cameras is output at the same time as a corresponding nth pixel of the data stream of the other camera.

Lines 3B and 3D show, respectively, the modified data stream DSA′ of line 2B of FIG. 2 and a modified data stream DSB″ produced from the data stream DSB₂. FIG. 3 shows again that while pixel data are validly asserted for one of the data streams, the other data stream is in a High-Z state, and vice versa. For example, at time t₄ the pixel data D_{1,1} of the data stream DSA′ coincides with a High-Z state Z₁ of the data stream DSB″; at time t₅ the pixel data D_{2,1} of the data stream DSB″ coincides with a High-Z state Z₂′ of the data stream DSA′; and at time t₆ the pixel data D_{1,2} of the data stream DSA′ coincides with a High-Z state Z₃ of the data stream DSB″.

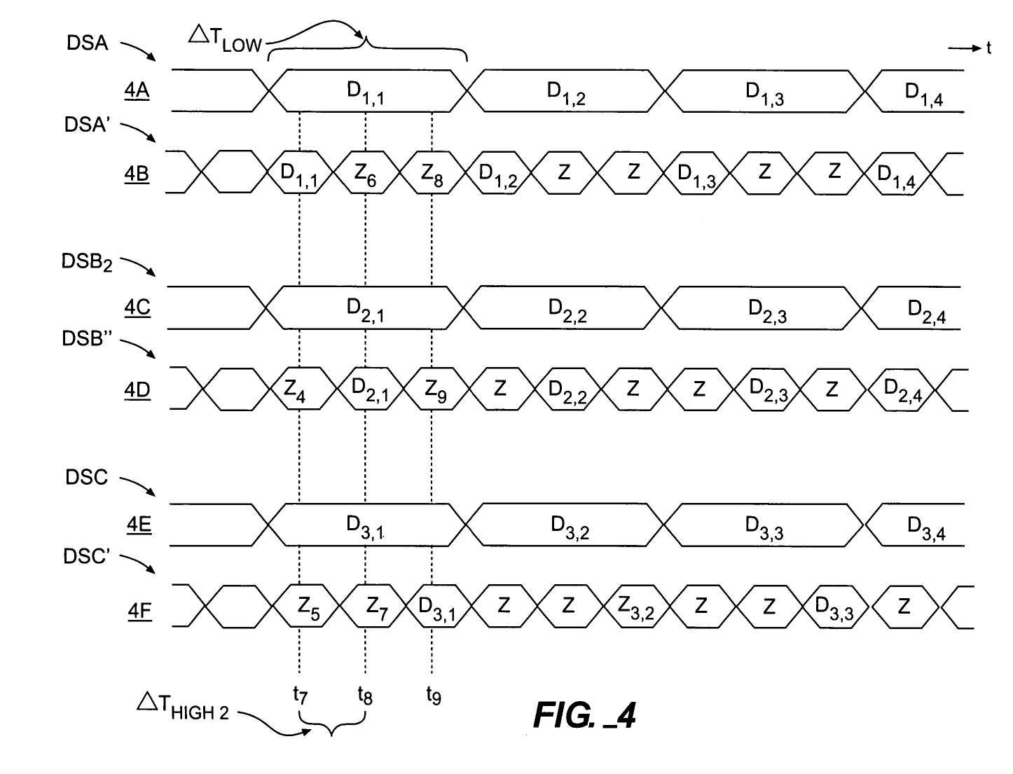

FIG. 4 depicts the data streams for an alternative embodiment. The lines 4A, 4C, and 4E designate data streams are produced by three data sources. Line 4A shows the data stream DSA for the camera module 15a; line 4C shows the data stream DSB₂ for the camera module 15b; and line 4E shows a third data stream DSC that may be assumed to correspond to a third device (not shown). Lines 4B, 4D, and 4F show the modified data streams DSA′, DSB″, and DSC′ produced, respectively, from the data streams DSA, DSB₂, and DSC.

FIG. 4 illustrates again that while pixel data are validly asserted for one of the data streams, the other data stream is in a High-Z state. For example, at time t₇, the pixel data D_{1,1} of the data stream DSA′ coincides with a High-Z state Z₄ of the data stream DSB″ and a High-Z state Z₅ of the data stream DSC′. At time t₈, the pixel data D_{2,1} of the data stream DSB″ coincides with a High-Z state Z₆ of the data stream DSA′ and a High-Z state Z₇ of the data stream DSC′. And at time t₉, the pixel data D_{3,1} of the data stream DSC′ coincides with a High-Z state Z₈ of the data stream DSA′ and a High-Z state Z₉ of the data stream DSB″. Accordingly, the three modified data streams DSA″, DSB″, and DSC″ may be superimposed on the bus 19 and valid data corresponding to just one of the cameras may be selected at the clock rate indicated by the period ΔT_{HIGH2}.

While a methodology has been described above with examples having two and three data streams, it is contemplated that the methodology may be advantageously employed with more than three data streams, corresponding to more than three data sources, which may or may not be cameras. For example, the third data source in the example shown in FIG. 4 may be a memory for storing image or audio data.

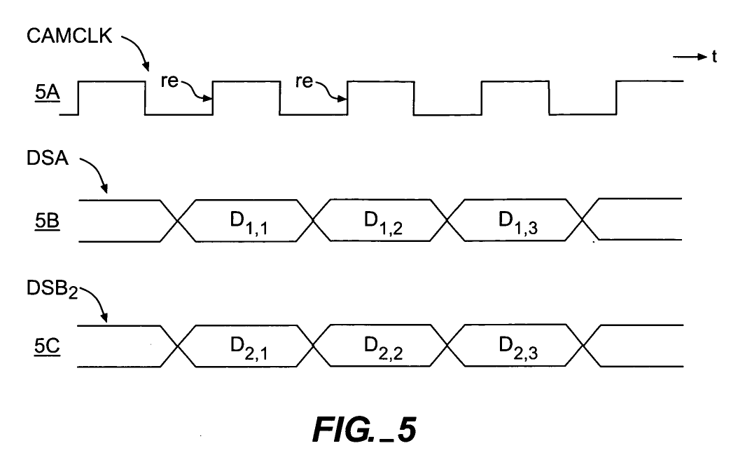

FIG. 5 shows the data streams produced by the cameras in one example. FIG. 5 depicts the data streams DSA and DSB₂ on lines 5B and 5C, which are produced, respectively, by the camera modules 15a and 15b. FIG. 5 also shows the CAMCLK which is shown on line 5A. In this example, the data streams are produced in synchronicity with the clock signal CAMCLK. Particularly, pixel data (D₁₁, D_{2,1}, D_{1,2}, D_{2,2}, etc.) are produced in timed relation to rising edges “re” of the signal CAMCLK.

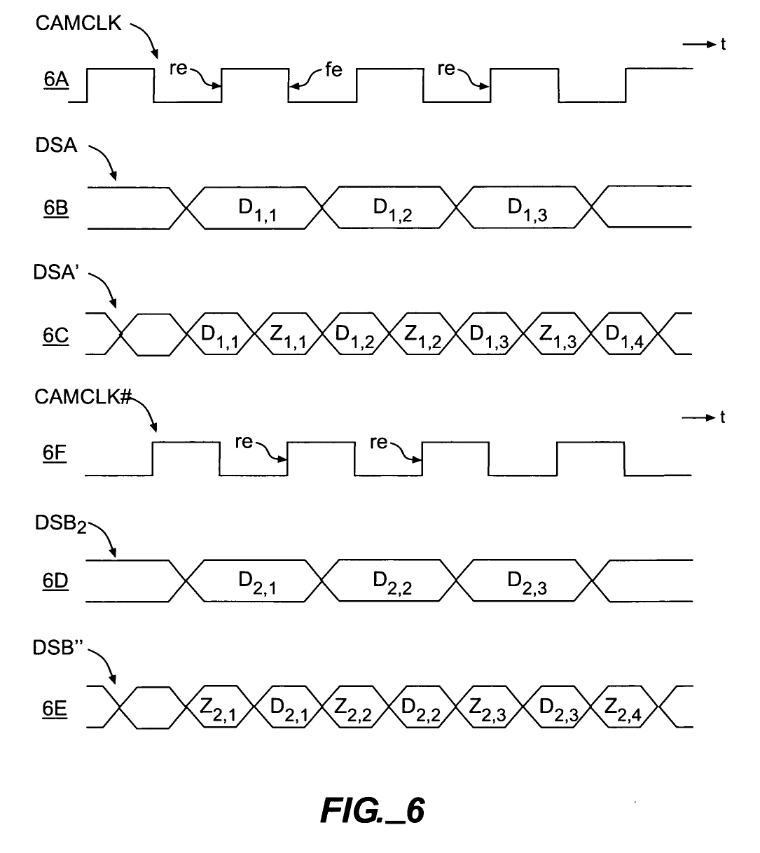

FIG. 6 shows the data streams produced by the cameras in another example together with the signals CAMCLK and CAMCLK#. FIG. 6 depicts original data streams DSA and DSB₂ on lines 6B and 6D which are produced, respectively, by the camera modules 15a and 15b. Also shown are the modified data streams DSA′ and DSB″ on lines 6C and 6E, respectively. As in the example above, DSA′ is produced from DSA, and DSB″ is produced from DSB₂.

To permit the interleaving of the two or more original data streams, High-Z states are inserted into the original data streams to produce corresponding modified data streams. For example, to produce the modified data stream DSA′ shown in FIG. 6, the corresponding original data stream DSA is sampled. Referring again to FIG. 1, the data stream DSA is provided to the input A to buffer 20a. The data stream DSA is sampled when the buffer 20a is enabled. Referring to FIG. 6, the buffer 20a is enabled on the rising edges “re” of the signal CAMCLK. A High-Z state is triggered, i.e., the buffer 20a output is disabled on the falling edges “fe” of the signal CAMCLK. Conversely, in one embodiment, to produce the modified data stream DSB″, the corresponding original data stream DSB₂ is sampled on the falling edges “fe” of CAMCLK. A High-Z state of the buffer 20b output is triggered on the rising edges “fe” CAMCLK.

To achieve the sampling and High-Z state triggering, the switching circuits 24a and 24b, which are depicted in the exemplary system shown in FIG. 1, are coordinated by use of an enable control circuit 30 in the graphics controller 10. Preferably, the switching circuits produce an alternating enable signal synchronized with the alternations of the clock signal CAMCLK. In this way, the enable signal is either in-phase or 180 degrees out-of-phase with the clock signal. The enable control circuit 30 sets a timing choice (in-phase or 180 degrees out-of-phase) for each camera by writing to respective enable control registers R1 and R2 in the two cameras 15 through the control interface 13.

The data interface 17 receives pixel data streamed from the cameras 15. The data interface 17 is coupled to a sampling circuit 32. The sampling circuit 32 samples the data streams as the data streams are received by the data interface 17. Preferably, the sampling circuit 32 includes one or more registers (not shown) for defining the superimposed data streams. As one example, a first sampling circuit register specifies that there are two camera data streams, and a second sampling circuit register specifies which of the cameras is set to provided data in-phase with the clock signal.

Referring again to FIG. 6, as mentioned above a CAMCLK# signal is shown. It is generally desirable to trigger only on rising edges of a clock signal. For this reason, in an alternative embodiment, the signal CAMCLK# (line 6F) is preferably generated for sampling the original data stream DSB₂ on rising edges of the signal CAMCLK#. It can be seen from the figure that CAMCLK# is a negated version of CAMCLK. The rising edges of signal CAMCLK is used for triggering High-Z states shown on line 6E. Alternatively, another clock signal MODCLK can be generated, as described below.

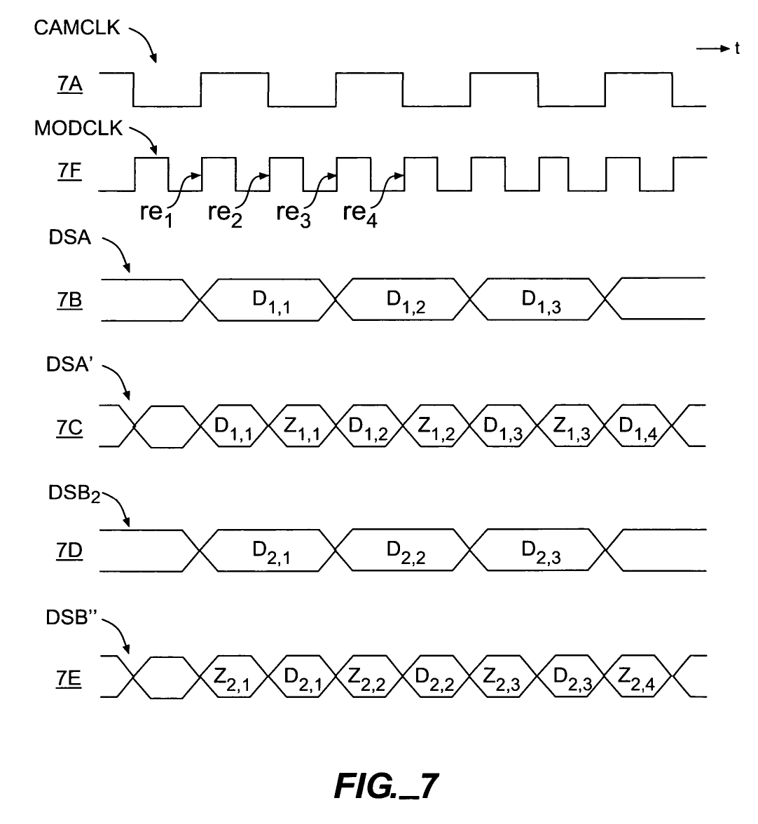

FIG. 7 shows the signal CAMCLK and the signal MODCLK having twice the frequency of the signal CAMCLK. In FIG. 7, line 7A shows CAMCLK and line 7F shows MODCLK. The original data streams DSA and DSB₂ are shown on lines 7B and 7D, respectively. As in the examples above, the original data stream DSA is produced by camera 15a, and the original data stream DSB₂ is produced by camera 15b. FIG. 7 also shows the data streams DSA′ and DSB″ produced, respectively, from DSA and DSB₂. See lines 7C and 7E. Data in DSA are sampled on odd numbered rising edges “re₁,” “re₃,” (and so on) of the signal MODCLK, while High-Z states are produced in buffer 20a on even numbered rising edges “re₂,” “re₄,” (and so on) of MODCLK. Similarly, DSB₂ is sampled on even numbered rising edges “re₂,” “re₄,” (and so on) of MODCLK, while High-Z states are produced in buffer 20b on odd numbered rising edges “re₁,” “re₃,” (and so on). As will be readily appreciated, falling edges of the signal MODCLK may be used as an alternative.

Referring again to FIG. 4, to produce the three modified data streams DSA′, DSB″, and DSC′ of lines 4B, 4D, and 4F, respectively, a modified signal analogous to the signal MODCLK may be used that has a frequency that is three times that of the signal CAMCLK. Interleaving of pixel data and High-Z states is accomplished analogously to that described immediately above in connection with use of the signal MODCLK in the case of two cameras 15, i.e., each of the modified data streams will be sampled on every third rising (or falling) edge, the rising edges for each data stream being shifted in time with respect to the rising edges for the other data streams. Further generalization to additional data streams follows straightforwardly.

The invention provides the outstanding advantage of providing an exceptionally low cost alternative to multiplexing the output of multiple cameras on a single parallel data interface, for realizing savings in hardware cost and power consumption that are important in low-cost, battery powered consumer appliances such as cellular telephones. It is especially advantageous that the invention provides for the elimination of at least one parallel bus.

The camera modules 15a and 15b are preferably substantially the same, i.e., they are of the same manufacture and of the same model or type, so that their timing will be optimally matched for synchronization (“matched”); however, this is not essential to the invention.

In the examples presented herein, the multiple devices providing streaming data have been cameras outputting image data. However, any other device outputting image data may be substituted in alternative embodiments. All that is required of the streaming data source is that its output data stream be capable of being synchronized and modified as described herein. As one example, the device may be a memory, such as a flash memory or a hard disk drive. In one embodiment, the memory device is used for storing image data, which may have been previously captured by a camera module of the system 8, or which may have been transmitted to the system 8. In another embodiment, the memory device is used for storing audio files, such as mp3 or wav files, and the system 8 includes an audio output for playing the music files.

It should be understood that, while preferably implemented in hardware, the features and functionality described above could be implemented in a combination of hardware and software, or be implemented in software, provided the graphics controller is suitably adapted. For example, a program of instructions stored in a machine readable medium may be provided for execution in a processing device included in the graphics controller.

It is further to be understood that, while a specific method and apparatus for streaming data from multiple devices over a single data bus has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A method for streaming data from multiple devices over a single data bus, comprising:
causing first and second data streams produced respectively by first and second devices to be synchronized;
inserting into each of the data streams a plurality of corresponding high impedance states to form respective modified data streams in such a manner that the data corresponding to one of the modified data streams is present at the same time that another of the modified data streams is in a high impedance state; and
superimposing the modified data streams on the bus for selecting the data.

2. The method of claim 1, further comprising selecting the data by sampling the superimposed modified data streams.

3. The method of claim 2, further comprising providing at least two cameras for producing the first and second data streams.

4. The method of claim 3, further comprising a memory for producing a third data stream.

5. The method of claim 2, further comprising temporally shifting one of the data streams relative to the other to produce an anti-parallel alignment of the first and second data streams.

6. The method of claim 2, further comprising producing a parallel alignment of the first and second data streams.

7. An apparatus for streaming data from multiple devices, comprising:
a clock source for synchronizing first and second data streams produced respectively by two of the devices;
a switching circuit for inserting into the first data stream a plurality of high impedance states to form a first modified data stream, and for inserting into the second data stream a plurality of high impedance states to form a second modified data stream;
a controller for controlling the switching device in such manner that data corresponding to one of the first and second modified data streams is present at the same time that the other of the first and second modified data streams is in a high impedance state; and
a bus for receiving the modified first and second data streams in superimposition.

8. The apparatus of claim 7, further comprising a sampling circuit for selecting data by sampling the superimposed first and second modified data streams.

9. The apparatus of claim 8, wherein the controller is further adapted to cause the switching circuit to temporally shift one of the first and second data streams relative to the other to produce an anti-parallel alignment of the first and second data streams.

10. The apparatus of claim 8, wherein the controller is further adapted to cause the switching circuit to maintain a parallel alignment of the first and second data streams.

11. The apparatus of claim 8, further comprising at least two cameras, wherein a first portion of the switching circuit for forming the first modified data stream is provided integral with one of the cameras and a second portion of the switching circuit for forming the second modified data stream is provided integral with another of the cameras.

12. The apparatus of claim 7, further comprising at least two cameras for producing the first and second data streams, and a memory for producing a third data stream.

13. A system for streaming data from multiple cameras, comprising:
a host;
a display device;
a least two cameras;
a graphics controller for displaying the data received from the cameras on the display device, the graphics controller including a clock for synchronizing first and second data streams produced by the cameras and a switching circuit controller;
a switching circuit, comprising a first portion corresponding to one of the cameras for inserting into the first data stream a plurality of high impedance states to form a first modified data stream, and a second portion corresponding to another of the cameras for inserting into the second data stream a plurality of high impedance states to form a second modified data stream, wherein the switching circuit controller is adapted for causing the switching circuit to produce the first and second modified data streams in such manner that data corresponding to one of the modified data streams is present at the same time that another of the modified the data streams is in a high impedance state; and
a bus connecting the cameras and the graphics controller for receiving first and second modified data streams in superimposition.

14. The system of claim 13, wherein the graphics controller further comprises a sampling circuit for selecting the data by sampling the superimposed first and second modified data streams.

15. The system of claim 14, wherein the switching circuit controller is further adapted to cause the switching circuit to temporally shift one of the data streams relative to the other to produce an anti-parallel alignment of the first and second modified data streams.

16. The system of claim 14, wherein the switching circuit controller is further adapted to cause the switching circuit to maintain a parallel alignment of the first and second modified data streams.

17. The system of claim 16, wherein the first portion of the switching circuit is provided integral with one of the cameras and wherein the second portion of the switching circuit is provided integral with another of the cameras.

18. The system of claim 15, wherein the first portion of the switching circuit is provided integral with one of the cameras and wherein the second portion of the switching circuit is provided integral with another of the cameras.

19. The system of claim 14, wherein the first portion of the switching circuit is provided on-board one of the cameras and wherein the second portion of the switching circuit is provided on-board another of the cameras.

20. The system of claim 13, wherein the first portion of the switching circuit is provided on-board one of the cameras and wherein the second portion of the switching circuit is provided on-board another of the cameras.
